(19) United States
(12) Patent Application Publication
(10) Pub. No.: US 2006/0034044 A1
(43) Pub. Date: Feb. 16, 2006

(54) Portable DVD player having an externally-exposed LCD display

(75) Inventor: Randy Chang, Hong Kong (HK)

Correspondence Address: SQUIRE, SANDERS & DEMPSEY L.L.P, 600 HANSEN WAY, PALO ALTO, CA, 94304-1043, US

(73) Assignees: SINOLINK INCORPORATION LTD., KOWLONG (HK); CHINA NATIONAL ELECTRONICS IMP. & EXP. CORP., BEIJING (CN)

(21) Appl. No.: 11/038,973

(22) Filed: Jan. 18, 2005

(30) Foreign Application Priority Data
Aug. 16, 2004 (CN) 2004200879612

(51) Int. Cl. G06F 1/16

(52) U.S. Cl. 361/683; 361/681

(57) ABSTRACT

The present invention relates to a portable DVD player, in particular to a portable DVD player having an externally-exposed LCD display which is disposed on the top cover. A LCD display 2 is disposed on the outer surface of the top cover 1 of the DVD player, the LCD display 2 is connected with a flexible printed circuit at its one end and the other end of the flexible printed circuit is connected with the control, decoder and signal output circuits within the base 5 respectively. A driver circuit and a time-response control circuit are disposed in the top cover 1, and one end of the driver circuit and the time-response control circuit are connected with the flexible printed circuit and the other end is connected with the LCD display 2. Function control buttons 3 and a pair of speakers 4 are disposed on the outer surface of the base of the two sides of the said top cover 1. The present invention adopts the structure that directly installs the LCD display on the outer side of the top cover which replaces the DVD disk cover in other design, and also saving the space occupied by other DVD players when they are in working, while offering convenience for audiences to watch DVD.

### FIELD OF THE INVENTION

The present invention relates to a portable DVD player, in particular to a portable DVD player having an externally-exposed LCD display which is disposed on the top cover.

### BACKGROUND OF THE INVENTION

Portable DVD players are obtained by combining design concepts of the ordinary DVD player and notebook computer.

A commercially-available portable DVD player in the market typically consists of a base, a DVD disk cover, a top cover, a remote controller, an external power and an external battery, etc., wherein, a DVD laser lens module, a DVD mechanism module, a servo board, a decoder board, a power control circuit and so forth are disposed in the base, function control buttons, an input port and an output port, and a power on/off switch, etc. are disposed on the surface of the base, a LCD display, such as a TFT-LCD display, and a speaker are disposed on the inner side of the top cover.

When the portable DVD player in the prior art is in use, the top cover should be opened and overturned to make the TFT-LCD display facing audiences; and the function control buttons can only be operated when the top cover is opened. The commercially-available portable DVD players in the market include the following ones like: Samsung DVD-L100 (overturned type, as shown in FIG. 1), Panasonic DVD-LS50, Panasonic DVD-LX9 (overturned type), DVD-LX8 (overturned+foldable type), as well as Winmate PDP-1002/WN3104 (overturned+rotary type), etc.

### DESCRIPTION OF THE INVENTION

One object of the present invention is to provide consumers with a portable DVD player having an externally-exposed LCD display which is easy to use.

Another object of the present invention is to provide a portable DVD player having an externally-exposed LCD display which is more space-saving and more convenient than others when it is in use.

A further object of the present invention is to provide a portable DVD player having an externally-exposed LCD display which enables its users to operate the DVD by watching the commands shown on the LCD display.

The portable DVD player having an externally-exposed LCD display according to the present invention comprises a top cover 1, a LCD display 2, function control buttons 3, a pair of speakers 4, a base 5, a concave DVD disk seat 6, a DVD mechanism prime spindle (i.e., DVD disk fixing shaft) 7, and a hinge 8.

According to the present invention, the LCD display can be any suitable LCD display known to the person skilled in the art, such as a TFT-LCD display.

For the portable DVD player having an externally-exposed LCD display of the present invention, a LCD display 2 is disposed on the outer surface of the top cover 1, the LCD display 2 is connected with a flexible printed circuit in one end, and the other end of the flexible printed circuit is connected with the control, decoder and signal output circuitry in the base 5 respectively.

According to the portable DVD player having an externally-exposed LCD display of the present invention, a driver circuit and a time-response control circuit are further disposed in the top cover 1, and the ends of the drive circuit and the time-response control circuit are connected respectively with the flexible printed circuit and the other ends of the driver circuit and the time-response control circuit are connected respectively with the LCD display 2.

According to the portable DVD player having an externally-exposed LCD display of the present invention, one end of the flexible printed circuit is connected with the time-response control circuit, the driver circuit and the LCD display 2 respectively, and the other end is connected with the control, decoder and signal output circuitry in the base 5 respectively; the other ends of the time-response control circuit and the driver circuitry are connected with the LCD display 2 respectively; the top cover 1 is connected with the base 5 through the hinge 8, wherein, the flexible printed circuit goes through the hinge 8.

Video and audio signal output ports are disposed on the base 5. The laser lens module on the base 5 detects and the picks up signals reflected from DVD disk for video and/or audio signals, the video signals are processed and output to the LCD display 2 through the flexible printed circuit and the audio signals are processed and output to the speaker 4 through the signal output circuit, or alternatively, the video signals are processed and output to an external display devices through the video output ports on the side surface of the base and the audio signal are processed and output to an external speaker devices through the audio output ports on the side surface of the base.

According to the portable DVD player having an externally-exposed LCD display of the present invention, function control buttons 3 and a pair of speakers 4 are further disposed on the two sides of the top cover of the external surface of the base. The function control buttons 3 are connected with the control circuit in the base 5 and the speakers 4 are connected with the signal output circuit in the base 5.

A concave disk seat is disposed on the cupped surface between the base and the top cover, and a DVD mechanism prime spindle (i.e., DVD disk fixing shaft) is disposed on the center of the concave disk seat.

The inner structure of the base of the present invention is similar to that of common portable DVD players in the market, wherein, a DVD laser lens module, a mechanism, a servo board, a decoder PCB, a power control circuit and other components are provided, and function control buttons, signal input and output ports, a power on/off switch, etc. are disposed on the surface of the base.

The main differences between the DVD player of the present invention and the currently popular portable DVD players in the market are as follows:

(1) The LCD display is disposed on the outer side of the top cover, facing outside directly to audiences without opening and overturning the top cover;

(2) The DVD disk cover is not needed;

(3) The function control buttons are disposed on the surface of the base, allowing direct operations without opening the top cover;

(4) The speakers are disposed on the external surface of the top of the base of the two sides of the top cover.

The present invention adopts the structure that directly installs the LCD display on the outer side of the top cover to make the display facing outside. Meanwhile, the top cover is used to replace the DVD disk cover used in other designs and the DVD disk cover is not necessary anymore, and the speakers and the function control buttons are disposed on the base of the two sides of the top cover to make them facing outside, so that the function control buttons can be seen and operated without opening the top cover, and saving the space occupied by other DVD players when they are in working, while offering convenience for audiences to watch DVD.

### BRIEF DESCRIPTION OF THE DRAWINGS

FIG. 1 is a schematic view of a portable DVD player of the prior art.

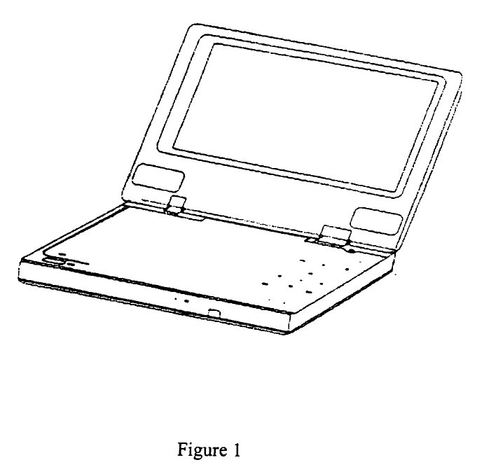

FIG. 2 is a schematic view of the first embodiment of the present invention.

FIG. 3 is a schematic view of the second embodiment of the present invention.

### REFERENCES IN THE DRAWINGS

| | | |
|---|---|---|
| 1. Top cover | 2. LCD display | 3. Function control buttons |
| 4. Speakers | 5. Base | 6. concave DVD disk seat |
| 7. DVD mechanism prime | 8. Hinge | |
| spindle (i.e., DVD disk | | |
| fixing shaft) | | |

### DETAILED DESCRIPTION OF THE PREFERRED EMBODIMENTS

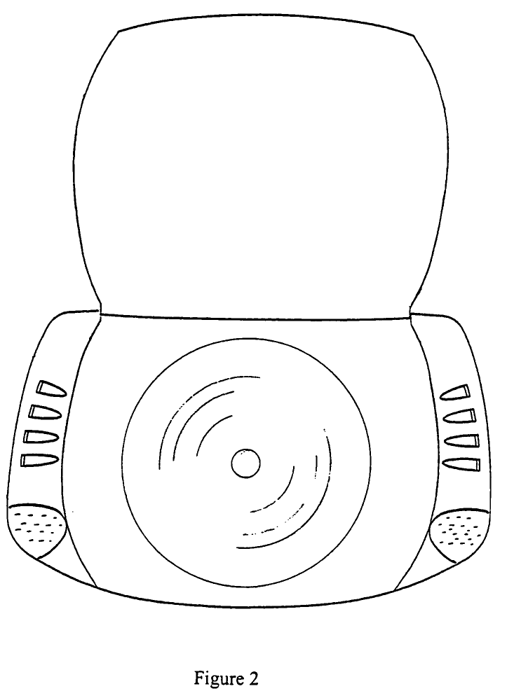

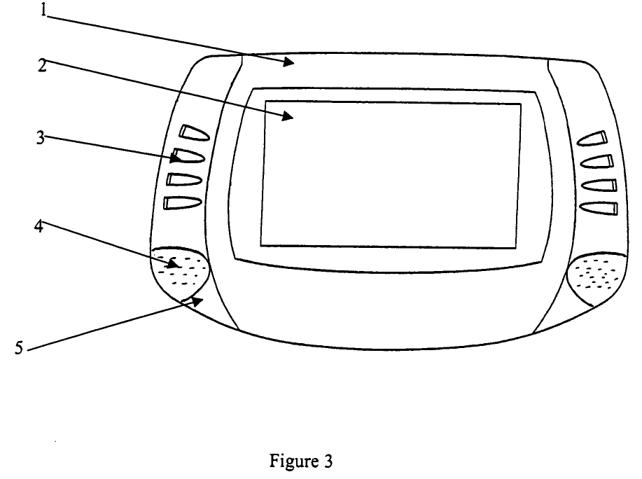

Please refer to FIG. 2 and FIG. 3. As shown in the Figures, the present invention provides a portable DVD player having an externally-exposed LCD display, which comprises a top cover 1, a LCD display 2, function control buttons 3, a pair of speakers 4, a base 5, a concave DVD disk seat 6, a DVD mechanism prime spindle (i.e., DVD disk fixing shaft) 7, a hinge 8. The LCD display 2 can be a TFT-LCD display and is disposed on the outer surface of the top cover 1 of the portable DVD player having an externally-exposed LCD display. A driver circuit and a time-response control circuit are disposed in the top cover 1. One end of a flexible printed circuit which goes through the hinge 8 connects with the time-response control circuit, the drive circuit and the LCD display 2 respectively, and the other end of the flexible printed circuit connects with the control, decoder and signal output circuitry in the base 5 respectively; the other ends of the time-response control circuit and the driver circuit connect with the LCD display 2; the top cover 1 connects with the base 5 through the hinge 8.

The function control buttons 3 and the speakers 4 are disposed on the outer surface of the base of the two sides of the top cover 1. The function control buttons 3 connect with the control circuit in the base, and the speakers 4 connect with the signal output circuit in the base.

A concave DVD disk seat is disposed on the cupped surface between the DVD player base 5 and the top cover 1, and a DVD mechanism prime spindle (i.e., DVD disk fixing shaft) is disposed on the center of the concave DVD disk seat, a DVD laser lens module, a DVD mechanism, a servo board, a decoder PCB, a power control circuit and so forth are disposed in the base.

The use of operations are as follows: the DVD player is switched on, then a DVD disk to be played is placed into the concave DVD disk seat 6 of the base 5, and then the top cover 1 is closed. The DVD player takes and transfers the signals that the laser lens module of the base 5 detects and picks up from the disk into video and/or audio signals, and the video signals are output to the LCD display 2 through the flexible printed circuit and the audio signals are output to the speakers 4 through the signal output circuit. At that time, user can use the function control buttons 3 on the upper and outer surface of the base 5 to choose or adjust the corresponding functions displayed on the display screen.

The user can connect external display devices or speaker devices onto the corresponding ports on the base 5. On the side surface of the base 5, the user can also tune the sound volume directly.

To stop, the user can directly press the STOP button of the function control buttons 3 to stop playing and take out the disk. Then pull out the power cord.

What is claimed is:

1. A portable DVD player having an externally-exposed LCD display, comprising:
a top cover (1), a LCD display (2), function control buttons (3), a pair of speakers (4), a base (5), a concave DVD disk seat (6), a DVD mechanism prime spindle (7), a hinge (8); characterized in that:
the LCD display (2) is disposed on the outer surface of the top cover (1), the LCD display (2) is connected with a flexible printed circuit at its one end and the other end of the flexible printed circuit is connected with the control, decoder and signal output circuitry within the base (5) respectively.

2. The DVD player as claimed in claim 1, wherein a driver circuit and a time-response control circuit are further disposed on the top cover (I), one end of the driver circuit and the time-response control circuit are connected with the flexible printed circuit respectively, and the other end is connected with the LCD display (2) respectively.

3. The DVD player as claimed in claim 1, wherein the top cover (1) is connected with the base (5) through the hinge (8), and the flexible printed circuit goes through the hinge (8).

4. The DVD player as claimed in claim 1, wherein function control buttons (3) and a pair of speakers (4) are disposed on the outer surface of the base of the two sides of the said top cover (1).

5. The DVD player as claimed in claim 1, wherein a concave DVD disk seat is disposed on the cupped surface between the base and the top cover, and a DVD mechanism prime spindle is disposed on the center of the concave DVD disk seat.

6. The DVD player as claims in claim 1, wherein the video and audio signal output ports are disposed on the said base (5).
